(19) United States
(12) Patent Application Publication
(10) Pub. No.: US 2017/0201476 A1
(43) Pub. Date: Jul. 13, 2017

(54) INFORMATION EXCHANGE METHODS AND DEVICES

(71) Applicant: Alibaba Group Holding Limited, George Town (KY)

(72) Inventors: Mengrui ZOU, Hangzhou (CN); Yilin MAO, Hangzhou (CN); Qinglong DUAN, Hangzhou (CN); Hao GAN, Hangzhou (CN); Zijun LIN, Hangzhou (CN); Yugang QIU, Hangzhou (CN); Lei FU, Hangzhou (CN); Jiawei FANG, Hangzhou (CN); Chunyang ZHANG, Hangzhou (CN); Jianhua FENG, Hangzhou (CN)

(21) Appl. No.: 15/400,511

(22) Filed: Jan. 6, 2017

(30) Foreign Application Priority Data
Jan. 7, 2016 (CN) 201610010086.5

(51) Int. Cl. H04L 12/58; H04L 29/08; H04L 29/06

(52) U.S. Cl. CPC H04L 51/04; H04L 67/42; H04L 67/32

(57) ABSTRACT

A multi-client (e.g., multi-person, multi-user, multi-device, or multi-node) information exchange method includes receiving a first request for a first client to enter a multi-client information exchange interface. The information exchange interface is operable for displaying information sent from clients including the first client. The information exchange interface is provided to the first client according to the first request. An exit request for the first client to exit the information exchange interface is received. The information sent from the clients is deleted in response to the exit request. Subsequent to the exit request, a second request for the first client to enter the information exchange interface is received. In response to the second request, information sent from clients since the exit request was received is displayed.

### RELATED APPLICATION

This application claims priority to Chinese Patent Application No. 201610010086.5, filed on Jan. 7, 2016, with the State Intellectual Property Office of the People's Republic of China, incorporated by reference in its entirety herein.

### FIELD

Embodiments according to the present disclosure relate to communications, and particularly relate to multi-client (e.g., multi-person, multi-user, multi-node, or multi-device) information exchange methods and devices that implement such methods.

### BACKGROUND

With the rapid development of the Internet, IM (Instant Messaging) software has become an important part of people's lives. People can discuss a topic freely with contacts such as friends, workmates, families, and the like in real time via a group function (“chat room”) enabled by the IM software. However, ensuring the security of messages in a group discussion (“group chat”) is a problem that needs to be resolved.

At present, the IM software addresses the security of chat room discussions primarily by loading and preserving messages only within a preset time period. Specifically, the point in time when a user enters a group chat is recorded, and only messages within a preset period of time (e.g., within ten minutes) before then are loaded, so that the user can only see the messages from within the preset period of time but cannot see messages from before then. This method can protect the privacy of messages and participants, but the use of a preset time period is not flexible enough. Also, because only a limited portion of the previous messages can be seen, a user new to the group chat cannot readily determine what has already been said about the discussion topic, and thus the context of visible messages may not be apparent. Moreover, if, for example, a user clicks on an icon multiple times when entering a group chat, the loaded messages are repeated. These issues can reduce the quality of users' experiences.

### SUMMARY

An aspect of the present disclosure is to improve multi-client (e.g., multi-person, multi-node, multi-user, or multi-device) information exchange methods and devices that implement such methods, thereby improving user experiences while ensuring the security of group chat content. Embodiments according to the present invention solve at least one of the problems described above.

In an embodiment, the present disclosure includes a method for exchanging information in a group having multiple clients (e.g., a multi-person, multi-user, multi-node, multi-client, or multi-device group), including the following steps: receiving a first request for a first client to enter a group information exchange interface, wherein the group information exchange interface is operable for displaying information sent from the clients including the first client; providing the group information exchange interface to the first client according to the first request; receiving an exit request for the first client to exit the group information exchange interface; deleting the information sent from the clients, in response to the exit request; subsequent to the exit request, receiving a second request for the first client to enter the information exchange interface; and in response to the second request, displaying information sent from clients since the exit request was received.

In an embodiment, the present disclosure provides a device for multi-client (e.g., multi-person, multi-user, multi-node, or multi-device) information exchange, including: a providing module, operable for receiving a first request for a first client to enter a multi-client information exchange interface, wherein the multi-client information exchange interface is operable for displaying information sent from clients including the first client and for providing the multi-client information exchange interface to the first client according to the first request; a delete module coupled to the providing module and operable for receiving an exit request for the first client to exit the multi-client information exchange interface and for deleting the information sent from the clients in response to the exit request; and a display module coupled to the providing module and operable for receiving a second request for the first client to enter the multi-client information exchange interface and, in response to the second request, for displaying information sent from clients since the exit request was received.

In an embodiment, the present disclosure also provides a method of communicating in a group chat, including the steps of: displaying a contact list, at a sender client device, in response to an instruction to initiate a group chat; and displaying a group chat window, in response to an instruction that one or more contacts has been selected from the contact list, wherein the group chat window is operable to display at least one message sent from the sender to the one or more contacts, and the group chat window is further operable to remove the at least one message in response to a determination that the sender exits and re-enters the group chat window.

Thus, in embodiments according to the multi-client information exchange methods and devices of the present disclosure, a first request sent by a first client to enter a multi-client information exchange interface is received, the multi-client information exchange interface is provided to the first client according to the first request, an exit request for the first client to the multi-client information exchange interface is received, the information which has been received by the first client (e.g., accessed or read by a first user) is deleted in response to the exit request, a second request sent by the first client to enter the multi-client information exchange interface is received, and information sent since the exit request (e.g., information not read by the first user) is displayed in response to the second request. Accordingly, the context of the group chat information (chat content) is available so that a user can conveniently catch up on the chat topic and smoothly re-enter the group chat. Also, the problem of reloading chat content when a client enters and re-enters the chat interface multiple times is solved, the security of the chat content is ensured, and user experiences are improved.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 is a flowchart of a multi-client information exchange method according to an embodiment of the present disclosure.

FIG. 2 is a flowchart of a multi-client information exchange method according to an embodiment of the present disclosure.

FIG. 3 illustrates an interface of creating a group chat by selecting one or more contacts from an address book or contact list according to an embodiment of the present disclosure.

FIG. 4 illustrates a notification interface that an advanced privacy group will be created according to an embodiment of the present disclosure.

FIG. 5 illustrates a group chat interface according to an embodiment of the present disclosure.

FIG. 6 illustrates a client chat interface according to an embodiment of the present disclosure.

FIG. 7 illustrates a session list interface according to an embodiment of the present disclosure.

FIG. 8 illustrates a group chat interface according to an embodiment of the present disclosure.

FIG. 9 is a block diagram of a multi-client information exchange device according to an embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “providing,” “displaying,” “deleting,” “acquiring,” “calculating,” “marking,” “determining,” or the like, refer to actions and processes of an apparatus or computer system or similar electronic computing device or processor. A computer system or similar electronic computing device manipulates and transforms data represented as physical (electronic) quantities within memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

Multi-client information exchange methods and devices that implement such methods in embodiments according to the present disclosure will be described below with reference to the accompanying drawings. In general, as used herein, the term “user” refers to a person, and the term “client” or “client device” refers to any type of device that a user might use for information exchange. Any exceptions will be made clear in the discussion below.

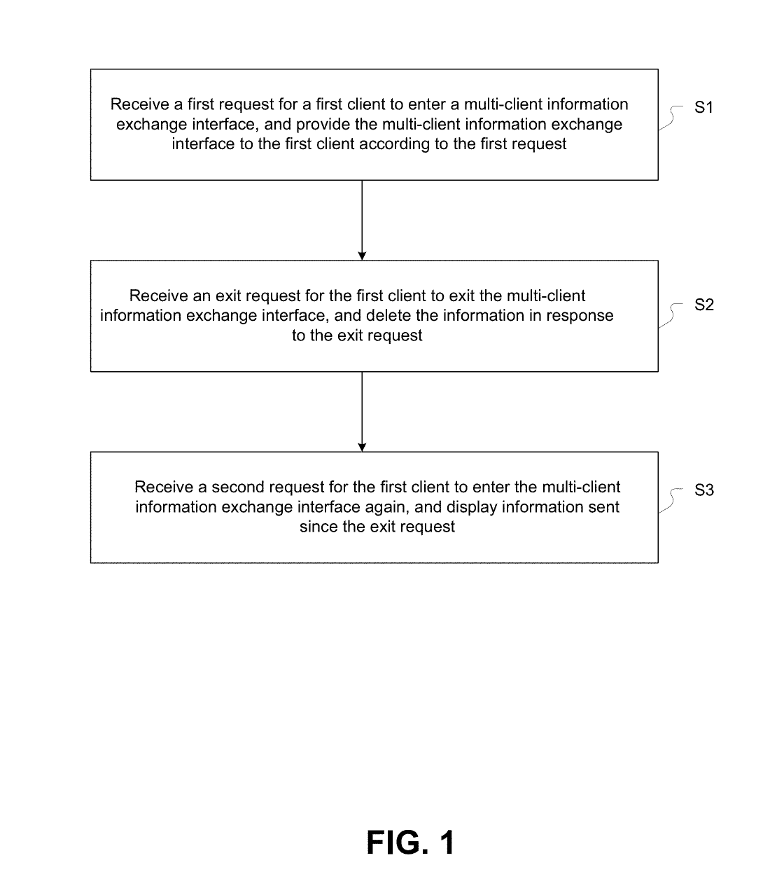

FIG. 1 is a flowchart of a method for exchanging information in a group having multiple clients (a multi-client or group information exchange) according to an embodiment of the present disclosure. In this embodiment, the operations shown in the flowchart and described below are performed by a client device, which may be also referred to herein as the first client device or the first client.

In block S1 of the flowchart, a first request for a first client to enter a multi-client information exchange interface is received. The multi-client information exchange interface is operable for displaying, on the first client device, information sent from multiple clients including the first client. In an embodiment, the multi-client information exchange interface is provided to the first client according to (in response to) the first request.

More specifically, a first user can input the first request for entering the multi-client information exchange interface to the first client device, and then the first client device provides (displays) the multi-client information exchange interface according to the first request. For example, the first user clicks the name of a group chat in a chat software interface (the first client device receives an input based on the clicks), and enters a group chat window interface corresponding to the group. The group chat window interface can display, on the first client device, chat information of (for) all clients/users in the group chat.

In block S2, an exit request for the first client to exit the multi-client information exchange interface is received, and the chat information sent from the other clients is deleted in response to the exit request. Thus, for example, the chat information that has been or may have been read by the first user is deleted according to (in response to) the exit request.

In an embodiment, a first time point when the first client enters the multi-client information exchange interface can be determined, and a second time point when the first client exits the multi-client information exchange interface can also be determined. The time interval between the first time point and the second time point can be calculated. Information sent from other clients or users in the group chat within the time interval can be marked. The information sent from the other clients or users within the time interval (the marked information) can be deleted.

More specifically, the first client device can determine or acquire a first time point when the first client enters the multi-client information exchange interface, and can also determine or acquire a second time point when the first client exits the multi-client information exchange interface. The first client device can calculate a time interval according to the first time point and the second time point (from the first time point to the second time point). During this time interval, the first user was or is assumed to have been a participant in the group chat. After the time interval is calculated, the first client device can mark the information sent within the time interval as information that the first client or first user had access to and/or that has been read by the first user. The first client device can then delete locally stored information (information stored on the first client device) that has been marked (e.g., that has been read or is presumed to have been read by the first user).

For example, if the first client enters a group chat window interface (e.g., the multi-client information exchange interface) at 10:00 am and exits the group chat window interface at 11:00 am, then the information sent by all clients in that group chat from 10:00 am until 11:00 am can be marked. When the first client exits the group chat window interface, the locally stored information that is marked can be deleted; that is, the information received from 10:00 am until 11:00 am and stored on the first client device can be deleted.

In an embodiment, the chat information for all the clients in the group chat, including the first client, is stored on a server. When the chat information is deleted from the first client device, the chat information is still stored by the server for at least some period of time.

In block S3, subsequent to the exit request of block S2, a second request for the first client to enter the multi-client information exchange interface is received. In response to the second request, information sent from clients in the group chat since the exit request was received is displayed on the first client device. Thus, information not accessible to and/or read by the first user between the exit request and the second request is displayed in response to the second request.

More specifically, the first client device can determine or acquire a third time point when the first client re-enters the multi-client information exchange interface, and then can determine whether new chat information was sent between the second time point and the third time point. If new chat information exists, the first client device can display the new information; if new chat information does not exist, the first client device can display preset prompt information that indicates that. Continuing with the above example, if the first client re-enters the group chat window interface at 1:00 pm, then the first client device can send a query request to the server, to inquire whether other clients in the group chat (other than the first client) sent chat information from 11:00 am to 1:00 pm. If other clients have sent chat information in that time interval, then the server can retrieve all information sent in that time interval and synchronize that information with the first client device, and the first client device can then display that information. Once the new information is displayed, that information can be marked as described above (e.g., as read information). If and when the first client later leaves the group chat window interface again, that information is deleted as described above and will not be displayed by the first client device if the first client once again re-enters the group chat window interface. If, on the other hand, other clients have not sent chat information from 11:00 am to 1:00 pm, then the first client device can display preset prompt information such as, for example, “the previous chat information has been deleted” or “all chat information will be deleted when exiting” or the like, thereby alerting the first client/user and ensuring the security of the chat information.

In an embodiment, after a preset time period expires, each of the client devices can delete the chat information sent by clients in the multi-client information exchange interface. For example, the chat information for the group chat may be stored on the client devices for only three days, in which case the client devices of the other users in the group chat will delete the corresponding chat information after three days. In such an embodiment, the server on which the chat information is stored also deletes the chat information for the group chat after the preset time period (e.g., three days) expires, thereby ensuring that the chat contents are not divulged.

In embodiments according to the disclosure, the chat information sent by clients in the multi-client information exchange interface cannot be disseminated.

That is, the chat information sent by any of the clients in the group chat cannot be copied, collected, or forwarded, for example, so that the security of the chat information is ensured. In such embodiments, if a client in a group chat executes an operation not meeting this requirement (e.g., a client attempts or performs a screenshot operation), the server can send an alert to other clients/users in the group chat after detecting the operation, to let the other users know that someone has executed a prohibited operation. This can help prevent more information from being divulged or disseminated. Prohibited operations can be predefined.

Thus, in embodiments according to the multi-client information exchange method of the present disclosure, a first request sent by a first client to enter a multi-client information exchange interface is received, the multi-client information exchange interface is provided to the first client according to the first request, an exit request for the first client to the multi-client information exchange interface is received, the chat information which has been received by the first client (e.g., accessed or read by the first user) is deleted in response to the exit request, a second request sent by the first client to enter the multi-client information exchange interface is received, and chat information sent since the exit request (e.g., information not read by the first client) is displayed on the first client device in response to the second request. Accordingly, the context of the chat information is available so that the first user can conveniently catch up on the chat topic and smoothly re-enter the group chat. Also, the problem of reloading the chat content when a client enters and re-enters the chat interface multiple times is solved, the security of the chat information is ensured, and user experiences are improved.

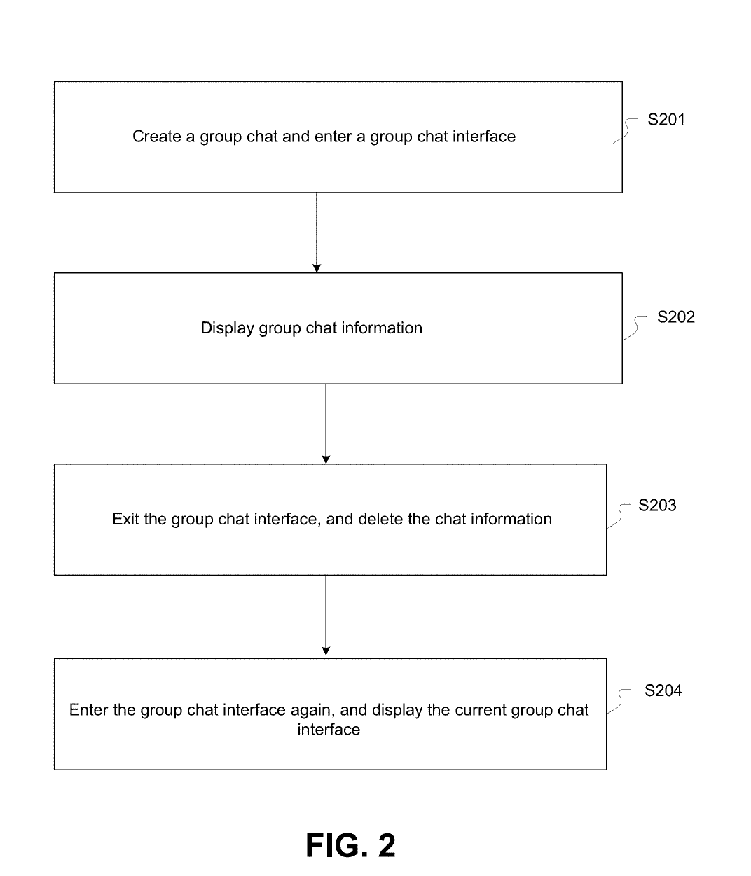

FIG. 2 is a flowchart of a multi-client information exchange method according to an embodiment of the present disclosure.

In block S201, a group chat is created and a group chat interface is entered.

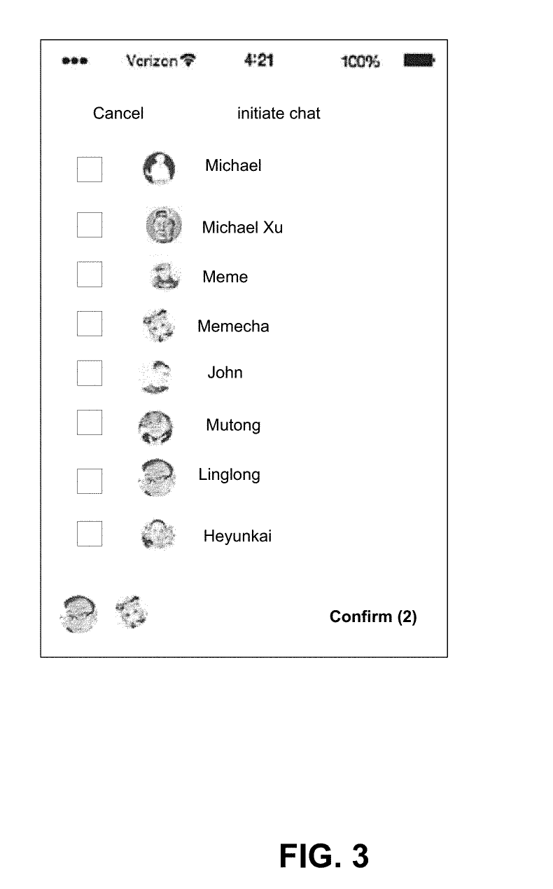

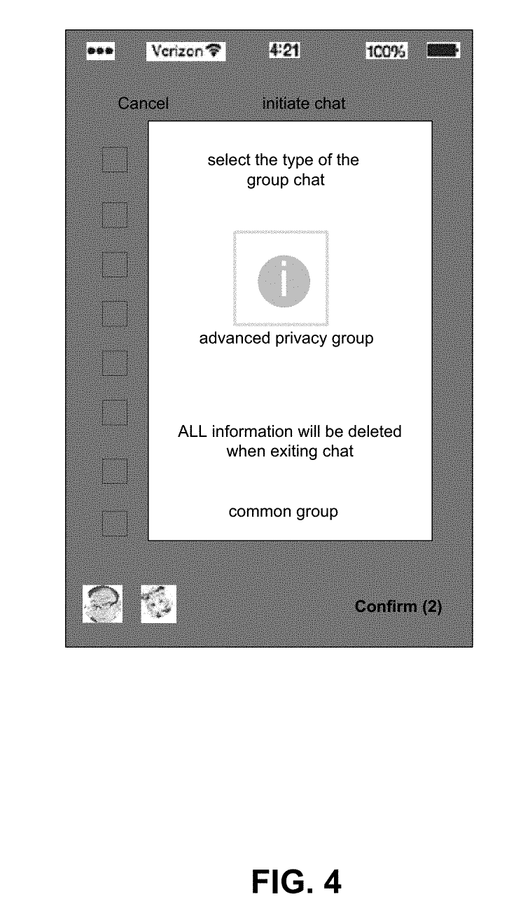

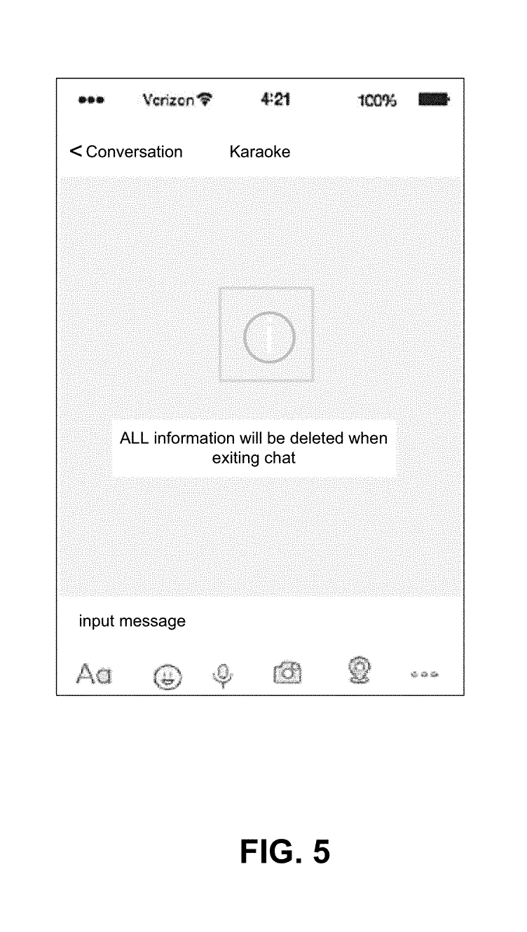

As shown in FIG. 3, clients/users can be selected for the group chat from an address book interface of instant messaging software, for example. After the clients/users are selected, then an advanced privacy group chat can be created as shown in FIG. 4 and named (e.g., “Karaoke”). Information sent by the clients in the advanced privacy group chat cannot be disseminated (e.g., copied, collected, or forwarded), and chat records (e.g., chat information or content) are automatically deleted after a preset time period (e.g., three days). In addition, operations that can be used to compromise privacy and disseminate chat information (e.g., a screenshot operation) are also prohibited. If a user or client in the group chat performs a prohibited operation, prompt information (e.g., an alert) can be sent to other users/clients in the group chat. After the advanced privacy group chat “Karaoke” is created, as shown in FIG. 5, the clients can enter the group chat interface for “Karaoke” and, for example, a prompt such as “All information will be deleted when exiting chat” is displayed.

In block S202 of FIG. 2, group chat information (records or entries) is displayed.

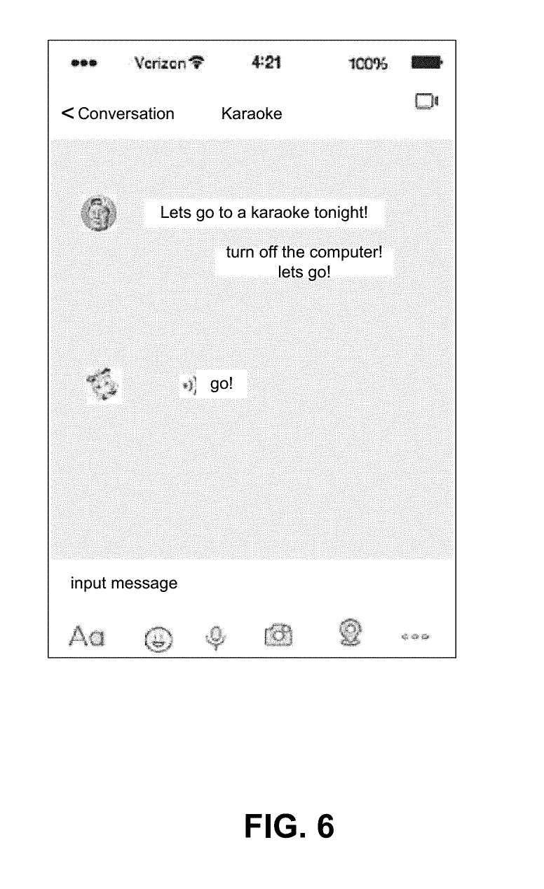

As shown in FIG. 6, after entering the group chat interface, a user can participate in a group chat with other users in the group chat “Karaoke” using their respective client devices.

In block S203 of FIG. 2, the group chat interface is exited and the chat information is deleted.

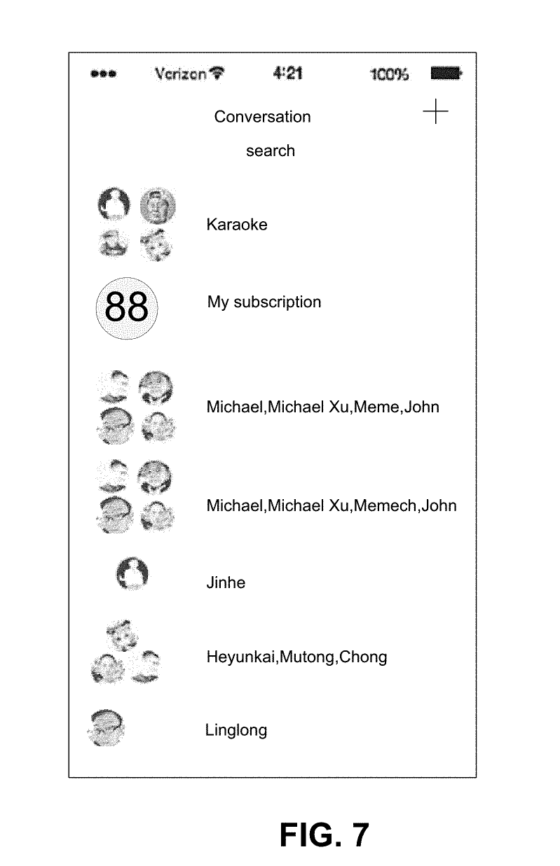

As shown in FIG. 7, after exiting the group chat interface of “Karaoke,” the client returns to a session list interface. Also, the client device deletes the chat information for the group chat “Karaoke.”

In block S204 of FIG. 2, the client re-enters the group chat interface, and the current group chat interface is displayed.

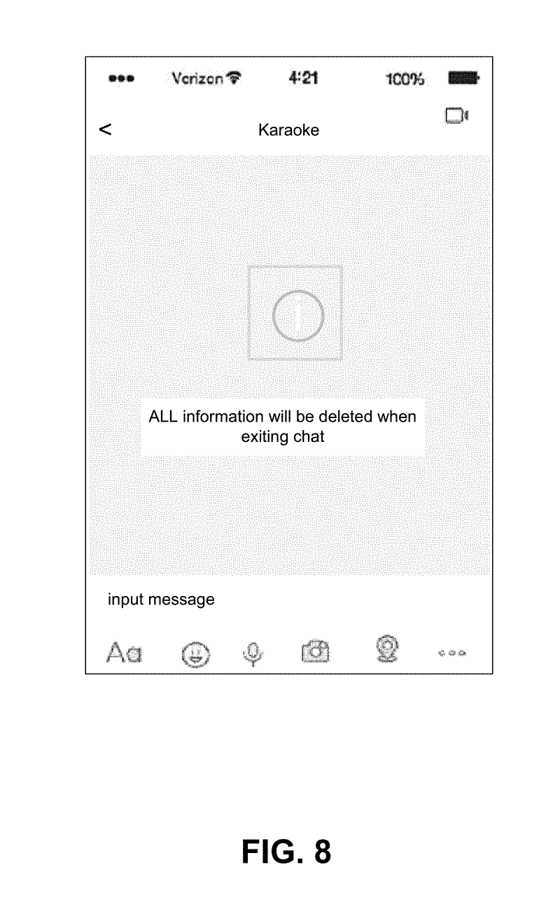

As shown in FIG. 8, the client re-enters the group chat interface of the group chat “Karaoke.” In the example of FIG. 8, after the client exited the group chat (block S203), other clients in the group chat did not send new chat information. Thus, in this example, when the client returned to the group chat interface, there is no new chat information, and only the group chat interface including a prompt such as “All information will be deleted when exiting chat” is displayed, indicating that the previous chat information (from the interval before the client exited the group chat) has been deleted.

Thus, according to the multi-client information exchange method in embodiments of the present disclosure, the chat information (records) on a client device are deleted in response to the client exiting the group chat interface, and chat information which has been deleted (e.g., read by a user of the client device) is not displayed when the client re-enters the group chat interface. Consequently, the problem of reloading group chat contents when a client re-enters the chat interface multiple times is solved, the security of the chat contents is ensured, and the user's experience is improved.

Embodiments according to the present disclosure also include a multi-client information exchange device that provides these advantages and functions.

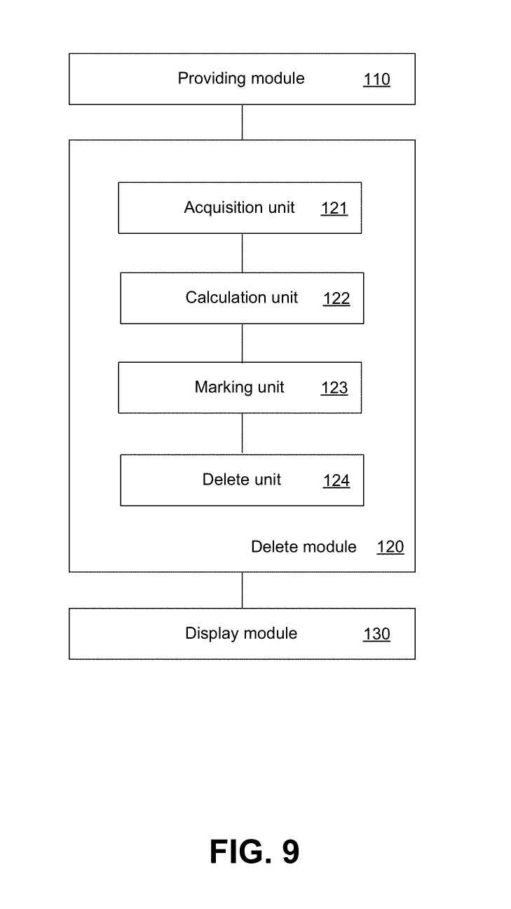

FIG. 9 is a block diagram of a multi-client information exchange device according to an embodiment of the present disclosure. The multi-client information exchange device is also referred to herein as a (first) client or (first) client device.

As shown in FIG. 9, the multi-client information exchange device may include a providing module 110, a delete module 120, and a display module 130. In an embodiment, the delete module 120 includes an acquisition unit 121, a calculation unit 122, a marking unit 123, and a delete unit 124. These modules and units may be implemented as computer-executable instructions residing in a computer-readable storage medium on the client device and executed by a processor of the client device.

The providing module 110 can receive a first request sent by a first client to enter a multi-client information exchange interface, and can provide the multi-client information exchange interface to the first client in response to the first request. Specifically, a first user can input a first request to enter a multi-client information exchange interface to the first client device, and then the providing module 110 can provide (display) the multi-client information exchange interface according to the first request. The multi-client information exchange interface is used for displaying chat information sent by multiple clients including the first client. For example, the first user selects (e.g., touches or clicks on) the name of a group chat in a graphical interface, and enters a group chat window interface corresponding to the selected group chat. The group chat window interface can display chat information for all clients in the group chat.

The delete module 120 can receive an exit request from the first client to exit the multi-client information exchange interface, and can delete the chat information which has been received by the first client (e.g., accessed and/or read by the first user) in response to the exit request.

In an embodiment, the delete module 120 includes an acquisition unit 121, a calculation unit 122, a marking unit 123, and a delete unit 124. In such an embodiment, the acquisition unit 121 can acquire or determine a first time point when the first client enters the multi-client information exchange interface, and can also acquire or determine a second time point when the first client exits the multi-client information exchange interface. The calculation unit 122 can calculate a time interval from the first time point to the second time point; this time interval corresponds to the time period during which the first client is in the multi-client information exchange interface. After the time interval is calculated, the marking unit 123 can mark the chat information sent from other clients within that time interval. The delete unit 124 can delete the marked information locally stored on the client device (e.g., the information that could have been read by the first user is deleted).

For example, if the first client enters the group chat window interface at 10:00 am and exits the group chat window interface at 11:00 am, then the chat information sent by all clients in the group chat from 10:00 am to 11:00 am can be marked (e.g., as information which was accessible to and could have been read by the first user within that time interval). When the first client exits the group chat window interface, the local chat information stored on the client device can be deleted. In an embodiment, a server also functions to store the chat information of all the clients in the group chat, and when the client device deletes the chat information, the corresponding chat information stored on the server is not affected (e.g., it is not deleted).

Moreover, after a preset time period expires, the delete module 120 can delete the information sent by the clients in the multi-client information exchange interface. For example, the chat information for the group chat may be stored for only three days, in which case the client devices of all the users that participated in that group chat delete the chat information corresponding to that group chat after three days. The chat information for that group chat can likewise be deleted from the server after the preset time period expires (e.g., after three days), thereby ensuring that the chat contents are not divulged.

The display module 130 can receive a second request for the first client to re-enter the multi-client information exchange interface and, in response to the second request, can display the chat information sent by the other clients since the exit request (e.g., the information that was not accessible to and could not have been read by the first user).

More specifically, the display module 130 can acquire or determine a third time point (after the second time point) when the first client re-enters the multi-client information exchange interface, and then determines whether new chat information was sent by other clients between the second time point and the third time point. If new chat information exists, the client device can display the new information; and if new information does not exist, then the client device can display preset prompt information. In the above example, if the first client re-enters the group chat window interface at 1:00 pm, then the client device can send a query request to the server, to inquire whether other clients in the group chat sent information in the interval from 11:00 am to 1:00 pm. If other clients have sent chat information in that interval, then the server can access or retrieve that information and synchronize the new information to the client device, and the client device displays the new information. After the new chat information is displayed, that information can be marked (e.g., as information that was or could have been read by the first user). If the first client then leaves but later re-enters the group chat window interface again, the marked information is no longer displayed. If, on the other hand, other clients have not sent chat information in the interval from 11:00 am to 1:00 pm, then the client device can display prompt information such as “the previous chat information has been deleted” or “all the chat information will be deleted when exiting chat” or the like, in order to alert the first user and also to thereby ensure the security of the chat information.

In summary, according to the multi-client information exchange device in embodiments of the present disclosure, a first request sent by a first client for entering a multi-client information exchange interface is received, the multi-client information exchange interface is provided to the first client in response to the first request, an exit request for the first client to exit the multi-client information exchange interface is received, group chat information which was sent between the first request and the exit request (information that was available to and could have been read by a user) is deleted in response to the exit request, a second request for the first client to re-enter the multi-client information exchange interface is received, and the group chat information sent between the exit request and the second request (information that was not available to and could not have been read by the user) is displayed in response to the second request. Consequently, the context of the chat information is available so that the user can conveniently catch up on the chat topic and smoothly re-enter the group chat. Also, the problem of reloading the chat content when a client enters and re-enters the chat interface multiple times is solved, the security of the chat information is ensured, and user experiences are improved.

The terms “first” and “second” are not intended to indicate the relative importance or imply the quantity of the indicated technical features. Thus, the features defined with “first” and “second” may explicitly or implicitly include at least one of the features. In the description of the present disclosure, “multiple” means at least two, e.g., two, three, etc., unless otherwise specified.

In the descriptions of the present disclosure, the descriptions with reference to the terms “one embodiment,” “some embodiments,” “example,” “specific example,” “some examples,” and the like are included in at least one embodiment or example of the present disclosure in combination with the specific feature, structure, material, or characteristic described by the embodiment or example. In these descriptions, the expression of such terms is not limited to the same embodiment or example. In addition, the described specific feature, structure, material, or characteristic may be combined in any one or more embodiments or examples in an appropriate mode. Moreover, those skilled in the art can combine different embodiments or examples described in the specification without conflict.

Although embodiments of the present disclosure have been shown and described above, it could be understood that the above embodiments are examples and cannot be regarded as limiting the present disclosure, and changes, modifications, substitutions and variations could be made by those of ordinary skill in the art within the scope of the present disclosure.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system and executed by a processor. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the disclosure.

Embodiments according to the disclosure are thus described. While the present disclosure has been described in particular embodiments, it should be appreciated that the disclosure should not be construed as limited by such embodiments, but rather construed according to the following claims.

What is claimed is:

1. A method for exchanging information in a group having a plurality of clients, comprising:
receiving a first request for a first client to enter a group information exchange interface, wherein the group information exchange interface is operable for displaying information sent from the plurality of clients including the first client;
providing the group information exchange interface to the first client according to the first request;
receiving an exit request for the first client to exit the group information exchange interface;
deleting the information sent from the plurality of clients, in response to the exit request;
subsequent to the exit request, receiving a second request for the first client to enter the group information exchange interface; and
in response to the second request, displaying information sent from the plurality of clients since the exit request was received.

2. The method of claim 1, wherein said deleting comprises:
determining a first time point when the first client enters the group information exchange interface and a second time point when the first client exits the group information exchange interface;
calculating a time interval between the first time point and the second time point;
marking information sent from the clients within the time interval; and
deleting the information sent from the clients within the time interval.

3. The method of claim 2, wherein said displaying comprises:
determining a third time point when the first client enters the group information exchange interface after the second time point;
determining whether information was sent by clients between the second time point and the third time point; and
displaying on the first client the information sent by clients between the second time point and the third time point if it exists, and if it does exist then displaying preset prompt information on the first client.

4. The method of claim 1, wherein information sent by clients in the group information exchange interface cannot be copied, collected, or forwarded.

5. The method of claim 1, further comprising, after a preset time period expires, deleting information sent by clients in the group information exchange interface.

6. The method of claim 1, further comprising:
determining that an operation not permitted in the group information exchange has been performed; and
sending an alert to the plurality of clients that the operation was performed.

7. The method of claim 1, wherein the information sent by the clients is deleted from the first client but continues to be stored on a server for a preset time period.

8. A device for multi-client information exchange, the device comprising:
a providing module, operable for receiving a first request for a first client to enter a multi-client information exchange interface, wherein the multi-client information exchange interface is operable for displaying information sent from a plurality of clients including the first client and for providing the multi-client information exchange interface to the first client according to the first request;
a delete module coupled to the providing module and operable for receiving an exit request for the first client to exit the multi-client information exchange interface and for deleting the information sent from the clients in response to the exit request; and
a display module coupled to the providing module and operable for receiving a second request for the first client to enter the multi-client information exchange interface and for displaying information sent from clients since the exit request was received in response to the second request.

9. The device of claim 8, wherein the delete module comprises:
an acquisition unit operable for determining a first time point when the first client enters the multi-client information exchange interface and a second time point when the first client exits the multi-client information exchange interface;
a calculation unit operable for calculating a time interval between the first time point and the second time point;
a marking unit operable for marking information sent from the clients within the time interval; and
a delete unit operable for deleting the information sent from the clients within the time interval.

10. The device of claim 8, wherein the display module is further operable for:
determining a third time point when the first client enters the multi-client information exchange interface after the second time point;
determining whether information was sent by clients between the second time point and the third time point; and
displaying the information sent by clients between the second time point and the third time point if it exists, and if it does exist then displaying preset prompt information.

11. The device of claim 8, wherein information sent by clients in the multi-client information exchange interface cannot be copied, collected, or forwarded.

12. The device of claim 8, wherein the delete module is further operable for deleting, after a preset time period expires, information sent by clients in the multi-client information exchange interface.

13. The device of claim 8, further operable for receiving an alert that an operation not permitted in the multi-client information exchange has been performed.

14. The device of claim 8, wherein the information sent by the clients is deleted from the device but continues to be stored on a server for a preset time period.

15. A computer-readable storage medium having stored thereon computer-executable instructions that, when executed by a processor of a device, perform a method comprising:
receiving a first request for a first client to enter a multi-client information exchange interface, wherein the multi-client information exchange interface is operable for displaying information sent from a plurality of clients including the first client;
providing the multi-client information exchange interface to the first client according to the first request;
receiving an exit request for the first client to exit the multi-client information exchange interface;
deleting the information sent from the clients in response to the exit request;
subsequent to the exit request, receiving a second request for the first client to enter the multi-client information exchange interface; and
in response to the second request, displaying information sent from clients since the exit request was received.

16. The computer-readable storage medium of claim 15, wherein said deleting comprises:
determining a first time point when the first client enters the multi-client information exchange interface and a second time point when the first client exits the multi-client information exchange interface;
calculating a time interval between the first time point and the second time point;
marking information sent from the clients within the time interval; and
deleting the information sent from the clients within the time interval.

17. The computer-readable storage medium of claim 16, wherein said displaying comprises:
determining a third time point when the first client enters the multi-client information exchange interface after the second time point;
determining whether information was sent by clients between the second time point and the third time point; and
displaying the information sent by clients between the second time point and the third time point if it exists, and if it does exist then displaying preset prompt information.

18. The computer-readable storage medium of claim 15, wherein information sent by clients in the multi-client information exchange interface cannot be copied, collected, or forwarded.

19. The computer-readable storage medium of claim 15, wherein the method further comprises, after a preset time period expires, deleting information sent by clients in the multi-client information exchange interface.

20. The computer-readable storage medium of claim 15, wherein the method further comprises:
determining that an operation not permitted in the multi-client information exchange has been performed; and
sending an alert to the plurality of clients that the operation was performed.

21. A method of communicating in a group chat, comprising:
displaying a contact list, at a sender client device, in response to an instruction to initiate a group chat; and
displaying a group chat window, in response to an instruction that one or more contacts has been selected from the contact list, wherein the group chat window is operable to display at least one message sent from the sender to the one or more contacts, and the group chat window is further operable to remove the at least one message in response to a determination that the sender exits and re-enters the group chat window.
